(19) United States
(12) Patent Application Publication
(10) Pub. No.: US 2017/0264878 A1
(43) Pub. Date: Sep. 14, 2017

(54) SCANNING DEVICE AND OPERATING METHOD THEREOF

(71) Applicant: ELECTRONICS AND TELECOMMUNICATIONS RESEARCH INSTITUTE, Daejeon (KR)

(72) Inventors: Min Hyup SONG, Daejeon (KR); Bong Ki MHEEN, Daejeon (KR); Hong-Seok SEO, Daejeon (KR); Gyu Dong CHOI, Daejeon (KR)

(73) Assignee: ELECTRONICS AND TELECOMMUNICATIONS RESEARCH INSTITUTE, Daejeon (KR)

(21) Appl. No.: 15/208,577

(22) Filed: Jul. 12, 2016

(30) Foreign Application Priority Data
Mar. 9, 2016 (KR) 10-2016-0028498

(51) Int. Cl. H04N 13/00; G01S 17/89; H04N 13/02

(52) U.S. Cl. CPC H04N 13/004; H04N 13/0253; H04N 13/0217; G01S 17/89

(57) ABSTRACT

Provided herein is a scanning device including a transmitting module dividing a subject into a plurality of image regions and emitting laser beam onto the plurality of image regions by an interlaced method, a receiving module receiving reflected laser beam from the subject, and a signal processing module scanning a shape of the subject by a Time Of Flight (TOF) technique based on the reflected laser beam, wherein the signal processing module generates a single image with respect to the shape of the subject by overlapping subframes generated by the interlaced method.

### CROSS-REFERENCE TO RELATED APPLICATION

The present application claims priority to Korean patent application number 10-2016-0028498 filed on Mar. 9, 2016, the entire disclosure of which is incorporated herein in its entirety by reference.

### BACKGROUND

Field of Invention

Various embodiments of the inventive concept of the present disclosure relate to a scanning device, and more particularly, to an operating method thereof.

Description of Related Art

A high-speed acquisition method of a three-dimensional (3D) image is a requisite for rapid and accurate object recognition and operation control. A 3D image sensor capable of obtaining a 3D image at high speed may be utilized in various industries, such as machineries, robots, automobiles, automobile industries, and game/education contents business. Particularly, most of the industries requiring unmanned systems and automation will take full advantage of 3D image sensors.

Techniques for three-dimensionally recognizing space may be divided into an active method and a passive method by which light is emitted depending on whether a light source is used or not. The active method has come to prominence in comparison with the passive method. The active method is based on a Time of Flight (TOF) technique by emitting an optical energy of a predetermined pattern onto a subject and using a reflection time difference caused by the optical energy reflected and returned from the object.

The TOF technique may use a pulsed or modulated continuous wave light source as the optical energy. Space may be recognized by calculating the time during which the optical energy is reflected and returned from the subject and calculating the distance between the light source and the subject. The TOF technique has high resolution and is useful for measuring a 3D image of a distant subject.

### SUMMARY

Various embodiments of the present disclosure are to form a high-speed and high-precision scanning three-dimensional (3D) image by generating a 3D image through software programming of a scanning pattern by using an interlaced method and an overlapping technique without additional hardware.

According to an embodiment, there is provided a scanning device including a transmitting module dividing a subject into a plurality of image regions and emitting laser beam onto the plurality of image regions by an interlaced method, a receiving module receiving reflected laser beam from the subject, and a signal processing module scanning a shape of the subject by a Time Of Flight (TOF) technique based on the reflected laser beam, wherein the signal processing module generates a single image with respect to the shape of the subject by overlapping subframes generated by the interlaced method.

The transmitting module may emit the laser beam onto the plurality of image regions along a first path and emit the laser beam along a second path starting from a scan end point of the first path ends, wherein the second path is in an opposite direction to the first path.

The first path and the second path may not overlap with each other.

The first path and the second path may alternate with each other at a predetermined distance on the plurality of image regions.

The signal processing module may generate a first subframe by using the laser beam reflected along the first path and a second subframe by using the laser beam reflected along the second path.

The signal processing module may generate the single image by overlapping the first subframe and the second subframe.

The single image may be a three-dimensional (3D) image.

According to another embodiment, there is provided a method of operating a scanning device, the method including dividing a subject into a plurality of image regions, emitting laser beam onto the plurality of image regions by an interlaced method, receiving reflected laser beam from the subject, and generating an image with respect to a shape of the subject by a Time Of Flight (TOF) technique based on the reflected laser beam.

The image may be a 3D image.

The emitting of the laser beam may include emitting the laser beam onto a first image region, among the plurality of image regions, along a first path, and emitting the laser beam onto remaining image regions along a second path separated from the first path by a predetermined distance.

A scan end point of the first path may coincide with a scan start point of the second path.

A direction of the first path may be opposite to a direction of the second path.

The direction of the first path may be in parallel with the direction of the second path.

The generating of the image may include generating a first subframe on the basis of the reflected laser beam along the first path, generating a second subframe on the basis of the reflected laser beam along the second path, and generating a single image by overlapping the first subframe and the second subframe.

The emitting of the laser beam may include emitting the laser beam onto the plurality of image regions along a bidirectional round trip path.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a schematic conceptual view of a scanning system according to an embodiment;

FIG. 2 is a block diagram illustrating a scanning device according to an embodiment;

FIG. 3 is a conceptual view illustrating a plurality of image regions according to an embodiment;

FIG. 4A is a conceptual view illustrating a method of emitting laser beam along a first scan path according to an embodiment;

FIG. 4B is a conceptual view illustrating a method of emitting laser beam along a second scan path according to an embodiment;

FIG. 4C is a conceptual view illustrating a method of operating a scanning device emitting laser beam along a first scan path and a second scan path shown in FIGS. 4A and 4B;

FIG. 5 is a conceptual view illustrating a method of operating a scanning device according to another embodiment;

FIG. 6 is a conceptual view illustrating a method of operating a scanning device according to another embodiment;

FIG. 7 is a conceptual view illustrating a method of operating a scanning device according to another embodiment;

FIG. 8A is a graph illustrating a single scanning operation of a conventional scanning device;

FIG. 8B is a graph illustrating a dual scanning operation of a scanning device according to an embodiment;

FIGS. 9A and 9B are conceptual views illustrating a car including a scanning device according to an embodiment; and

FIG. 10 is a flowchart illustrating a method of operating a scanning device according to an embodiment.

### DETAILED DESCRIPTION

Specific structural or functional descriptions of exemplary embodiments in accordance with a concept of the present invention which are disclosed in this specification are illustrated only to describe the exemplary embodiments in accordance with the concept of the present invention and the exemplary embodiments in accordance with the concept of the present invention may be carried out by various forms but the present invention is not limited to the exemplary embodiments described in this specification.

Various modifications and changes may be applied to the examples of embodiments in accordance with the concepts so that the examples of embodiments will be illustrated in the drawings and described in the specification. However, the examples of embodiments according to the concepts are not limited to the specific embodiments, but include all changes, equivalents, or alternatives which are included in the spirit and technical scope of the present disclosure.

Terminologies such as first or second may be used to describe various components but the components are not limited by the above terminologies. The above terminologies are used to distinguish one component from the other component, for example, a first component may be referred to as a second component without departing from a scope in accordance with the concept of the present disclosure and similarly, a second component may be referred to as a first component.

It should be understood that, when it is described that an element is “coupled” or “connected” to another element, the element may be directly coupled or directly connected to the other element or coupled or connected to the other element through a third element. On the contrary, it should be understood that when an element is referred to as being “directly connected to” or “directly coupled to” another element, another element does not intervene therebetween. Other expressions which describe the relationship between components, that is, “between” and “directly between”, or “adjacent to” and “directly adjacent to” need to be interpreted by the same manner.

Terminologies used in the present specification are used only to describe specific examples of embodiments, and are not intended to limit the present disclosure. A singular form may include a plural form if there is no clearly opposite meaning in the context. In the present specification, it should be understood that terms “include” or “have” indicate that a feature, a number, a step, an operation, a component, a part or the combination those of described in the specification is present, but do not exclude a possibility of presence or addition of one or more other features, numbers, steps, operations, components, parts or combinations thereof, in advance.

If it is not contrarily defined, all terms used herein including technological or scientific terms have the same meaning as those generally understood by a person with ordinary skill in the art. Terminologies which are defined in a generally used dictionary should be interpreted to have the same meaning as the meaning in the context of the related art but are not interpreted as an ideally or excessively formal meaning if they are not clearly defined in this specification.

Modules in the exemplary embodiments of may indicate a functional or structural coupling of hardware for executing and software for operating the hardware. For example, the modules may refer to a program code and a logical unit or group of a hardware resource for performing the code. However, it will be understood by a person skilled in the technical field of the present disclosure that the each module may not necessarily mean the physically edited codes, or a kind of hardware.

Hereinafter, embodiments of the invention will be described in detail with reference to the accompanying drawings.

FIG. 1 is a schematic conceptual view of a scanning system 10 according to an embodiment.

Referring to FIG. 1, the scanning system 10 may include a scanning device 100 and a subject 200.

The scanning device 100 may generate a three-dimensional (3D) image by emitting laser beam LS onto a subject 200 and using reflected laser beam RLS from the subject 200.

For example, the laser beam LS may be a pulsed or modulated continuous wave light source.

According to an embodiment, the scanning device 100 may include a laser radar system using a non-rotational detection system method based on a stationary integrated detector. The scanning device 100 including the above laser radar system may emit the laser beam LS onto the subject 200 and detect the reflected laser beam RLS by using a light receiving optical system and a large-area light receiving element. Information about intensity of the detected laser beam and reflection time thereof may be subjected to signal processing and formed as a 3D image.

The scanning device 100 including the laser radar system may be very useful for obtaining a high-speed, high-resolution 3D image. In addition, the scanning device 100 may be variably driven by changing a frame rate of the generated 3D image or an operating frequency of a pulse laser.

In addition, the scanning device 100 including the laser radar system may have various transmission and reception structures since a transmitting module 120 configured to emit optical energy and a receiving module 130 receiving reflected optical energy may not be aligned in pixel units. Therefore, based on needs for various applications, various technical modifications can be made to the scanning device 100 including the laser radar system with high applicability.

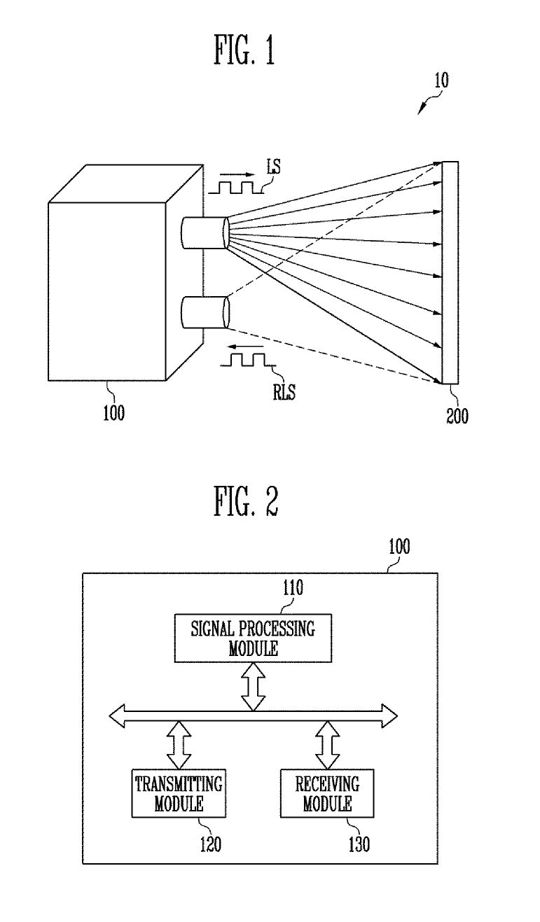

FIG. 2 is a block diagram illustrating a scanning device according to an embodiment.

Referring to FIG. 2, according to an embodiment, the scanning device 100 may include the transmitting module 120, the receiving module 130, and a signal processing module 110.

The transmitting module 120 may divide the subject 200 into a plurality of image regions and emit the laser beam LS onto the plurality of image regions by an interlaced method.

For example, the transmitting module 120 may emit the laser beam LS along a first path in a first direction from one side to the other side of the plurality of image regions, and may emit the laser beam LS along a second path in a direction opposite to the first direction. The first path and the second path may not overlap with each other, and the transmitting module 120 may emit the laser beam LS along the second path from a scan end point of the first path.

According to an embodiment, the first path and the second path may be arranged in parallel with each other at a predetermined distance in a direction vertical to the first direction.

According to another embodiment, the transmitting module 120 may continuously emit the laser beam LS onto the plurality of image regions along a nonlinear path.

The transmitting module 120 may perform a bidirectional round trip of a scanner by applying dual pattern scanning, but not single pattern scanning. Therefore, the scanning device 100 may prevent scanning consumption and disconnection by the transmitting module 120 performing the bidirectional round trip, and acquire 3D image data having a speed twice as fast as single pattern scanning.

The receiving module 130 may receive the reflected laser beam RLS reflected from the subject 200.

For example, the receiving module 130 may detect the reflected laser beam RLS by using a light receiving optical system and a large-area light receiving element.

The signal processing module 110 may generate subframes on the basis of the detected laser beam by using a Time of Flight (TOF) technique.

For example, the transmitting module 120 may emit the laser beam LS onto the plurality of image regions along various paths by an interlaced method, and the signal processing module 110 may generate subframes on the basis of the reflected laser beam RLS along the various paths.

The signal processing module 110 may generate a single 3D image with respect to the shape of the subject 200 by overlapping the subframes generated by the one subject 200.

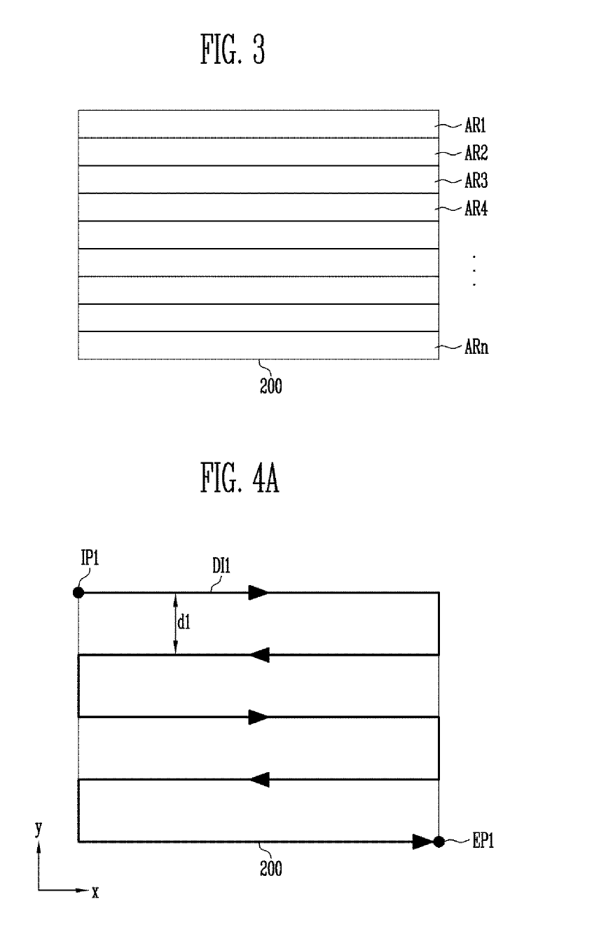

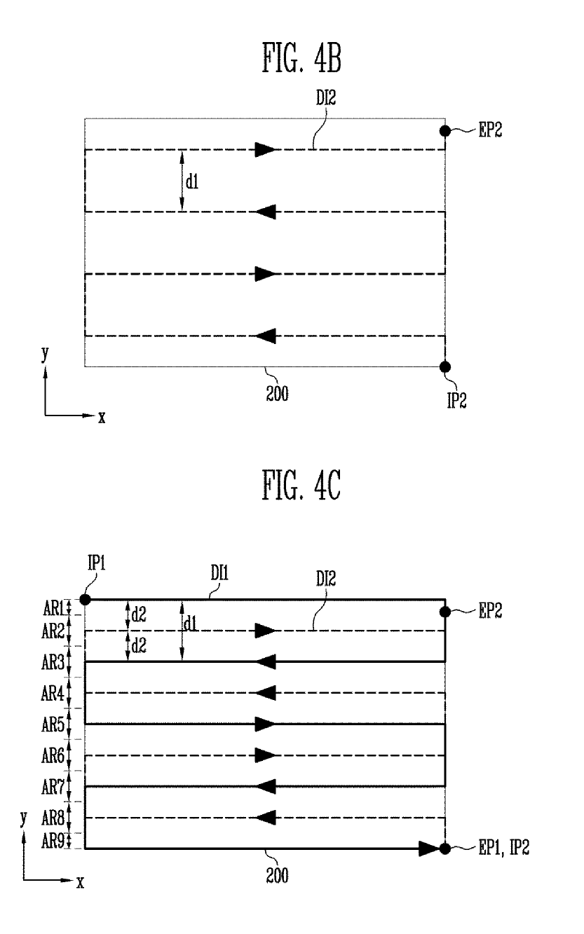

FIG. 3 is a conceptual view illustrating a plurality of image regions according to an embodiment. FIG. 4A is a conceptual view illustrating a method of emitting laser beam along a first scan path according to an embodiment. FIG. 4B is a conceptual view illustrating a method of emitting laser beam along a second scan path according to an embodiment. FIG. 4C is a conceptual view illustrating a method of operating a scanning device emitting laser beam along a first scan path and a second scan path shown in FIGS. 4A and 4B.

Referring to FIG. 3, the transmitting module 120 may divide the subject 200 into a plurality of image regions AR1 to ARn.

For convenience of explanation, the subject 200 shown in FIG. 3 may have a rectangular planar shape. However, according to an embodiment, the transmitting module 120 may divide the subject 200 having various shapes into the plurality of image regions AR1 to ARn.

Each of the image regions AR1 to ARn may include an area of the same size.

According to an embodiment, the plurality of image regions AR1 to ARn may be arranged in parallel with each other in an x-axis direction or a y-axis direction.

According to another embodiment, the image regions AR1 to ARn may be arranged in a lattice shape.

The transmitting module 120 emit the laser beam LS onto the plurality of image regions AR1 to ARn.

According to an embodiment, the transmitting module 120 may emit the laser beam LS onto the plurality of image regions AR1 to ARn along paths not overlapping with each other.

Referring to FIG. 4A, the transmitting module 120 may emit the laser beam LS onto the plurality of image regions AR1 to ARn along a first scan path DI1 by an interlaced method.

The first scan path DI1 may include a first path and a second path that alternate with each other. The first path may refer to a path from the left corner of the subject 200 to the right corner of the subject 200 in +x-axis direction. The second path may refer to a path from the right corner of the subject 200 to the left corner of the subject 200 in −x-axis direction.

In other words, the transmitting module 120 may emit the laser beam LS along the first and second paths alternating with each other and prevent disconnection of scanning by continuously emitting the laser beam LS onto paths between the first and second paths.

According to an embodiment, the first and second paths included in the first scan path DI1 may alternate with each other by a first distance d1. The first and second paths included in the first scan path DI1 may not overlap with each other.

More specifically, the transmitting module 120 may emit the laser beam LS from a first scan start point IP1 to the right corner of the subject 200 in the +x-axis direction (first path), emit the laser beam LS from the right corner of the subject 200 to a first point spaced apart from the right corner of the subject 200 by the first distance d1 in −y-axis direction, and emit the laser beam LS from the first point to the left corner of the subject 200 in −x-axis direction (second path).

In this manner, the transmitting module 120 may emit the laser beam LS from the first scan start point SP1 to a first scan end point EP1.

When the transmitting module 120 emits the laser beam LS along the first scan path DI1, the laser beam LS may be reflected from the subject 200 along the first scan path DI1, and the signal processing module 110 may generate a first subframe by using the reflected laser beam RLS along the first scan path DI1.

In other words, the scanning device 100 may generate the first subframe with respect to the shape of the subject 200 corresponding to the first scan path DI1.

Referring to FIG. 4B, the transmitting module 120 may emit the laser beam LS onto the plurality of image regions AR1 to ARn of the subject 200 along a second scan path DI2 by an interlaced method.

The second scan path DI2 may include a first path and a second path that alternate with each other. In substantially the same manner as the first scan path DI1, the transmitting module 120 may emit the laser beam LS onto the first and second paths alternating with each other along the second scan path DI2 and prevent disconnection of scanning by continuously emitting the laser beam LS onto paths between the first and second paths.

According to an embodiment, the first and second paths included in the second scan path DI2 may alternate with each other at the first distance d1. The first and second paths included in the second scan path DI2 may not overlap with each other.

More specifically, the transmitting module 120 may emit the laser beam LS from a second scan start point IP2 to a second point spaced apart by a second distance d2 in +y-axis direction, emit the laser beam LS from the second point to the left corner of the subject 200 in x-axis direction (second path), emit the laser beam LS from the left corner of the subject 200 to a third point separated from the second point by the first distance d1 in +y-axis direction, and emit the laser beam LS from the third point to the right corner of the subject 200 in +x-axis direction (first path).

In this manner, the transmitting module 120 may emit the laser beam LS from a second scan start point SP2 to a second scan end point EP2 along the first path and the second path.

When the transmitting module 120 emits the laser beam LS along the second scan path DI2, the laser beam LS may be reflected from the subject 200 along the second scan path DI2, and the signal processing module 110 may generate a second subframe by using the reflected laser beam RLS along the second scan path DI2.

In other words, the scanning device 100 may generate the second subframe with respect to the shape of the subject 200 corresponding to the second scan path DI2.

Referring to FIG. 4C, the transmitting module 120 may continuously emit the laser beam LS along the first scan path DI1 as shown in FIG. 4A and the second scan path DI2 as shown in FIG. 4B.

The transmitting module 120 may emit the laser beam LS from the first scan start point IP1 to the first scan end point EP1 along the first and second paths included in the first scan path DI1, and may emit the laser beam LS from the second scan start point IP2 to the second scan end point EP2 along the first and second paths included in the second scan path DI2.

The first scan end point EP1 and the second scan start point IP2 may be equal to each other. Therefore, after the transmitting module 120 emits the laser beam LS along the first scan path DI1, the transmitting module 120 may immediately emit the laser beam LS along the second scan path DI2.

The first and second paths of the first scan path DI1 may be disposed so as not to overlap with the first and second paths of the second scan path DI2.

For example, the first path of the first scan path DI1 may be included in a first image region AR1, a fifth image region AR5, and a ninth image region AR9, and the second path of the first scan path DI1 may be included in a third image region AR3 and a seventh image region AR7.

For example, the first path of the second scan path DI2 may be included in a second image region AR2 and a sixth image region AR6, and the second path of the second scan path DI2 may be included in a fourth image region AR4 and an eighth image region AR8.

In addition, the first and second paths of the first scan path DI1 may be separated from each other at a distance the same as the distance between the first path and the second path of the second scan path DI2.

For example, the first and second paths of the first scan path DI1 may be arranged at the first distance d1, and the first and second paths of the second scan path DI2 may be arranged at the first distance d1.

In addition, each of the first and second paths of the second scan path DI2 may be separated from each of the first and second paths of the first scan path DI1 by the second distance d2.

The signal processing module 110 may generate a single 3D image with respect to the shape of the subject 200 by overlapping the first subframe and the second subframe.

In other words, since each of the first subframe and the second subframe is an image which reflects a portion of the shape of the subject 200, the signal processing module 110 may scan the entire shape of the subject 200 by overlapping the first subframe and the second subframe.

According to an embodiment, since a scanning device uses dual pattern scanning and obtains an image by a bidirectional round trip of a scanner, the scanning device may scan a target at a speed twice as fast as single pattern scanning.

A jump to line by line interlaced method described with reference to FIGS. 4A to 4C is only an embodiment for a better understanding of the invention. However, the invention is not limited thereto, and various types of interlaced methods may be used.

FIG. 5 is a conceptual view illustrating a method of operating a scanning device according to another embodiment of the invention.

Since a jump over 2 line interlaced method shown in FIG. 5 includes similar technical features to the jump to line by line interlaced method shown in FIGS. 4A, 4B, and 4C, a detailed description thereof will be omitted.

Referring to FIG. 5, the transmitting module 120 may continuously emit the laser beam LS along a first scan path DI1′, a second scan path DI2′, and a third scan path DI3′.

The transmitting module 120 may emit the laser beam LS from a first scan point P1 to a second scan point P2 along the first scan path DI1′, emit the laser beam LS from the second scan point P2 to a third scan point P3 along the second scan path DI2′, and emit the laser beam LS from the third scan point P3 to a fourth scan point P4 along the third scan path DI3′.

The first scan path DI1′, the second scan path DI2′, and the third scan path DI3′ may be arranged at predetermined distances on the subject 200.

For example, first and second paths of the first scan path DI1′ may be separated from each other at a first distance d1′. In addition, each of the first scan path DI1′, the second scan path DI2′, and the third scan path DI3′ may be separated from a neighboring scan path at a second distance d2′.

The signal processing module 110 may generate a first subframe by using the reflected laser beam RLS along the first scan path DI1′, generate a second subframe by using the reflected laser beam RLS along the second scan path DI2′, and generate a third subframe by using the reflected laser beam RLS along the third scan path DI3′.

The signal processing module 110 may generate a single 3D image with respect to the shape of the subject 200 by overlapping the first subframe, the second subframe, and the third subframe.

In other words, since each of the first subframe, the second subframe, and the third subframe is an image reflecting a portion of the shape of the subject 200, the signal processing module 110 may scan the entire shape of the subject 200 by overlapping the first subframe, the second subframe, and the third subframe.

For convenience of explanation, the method of emitting the laser beam LS in order of the first scan path DI1′, the second scan path DI2′, and the third scan path DI3′ is illustrated. However, this method is merely an embodiment. The order in which the laser beam LS is emitted onto the first scan path DI1′, the second scan path DI2′, and the third scan path DI3′ may vary.

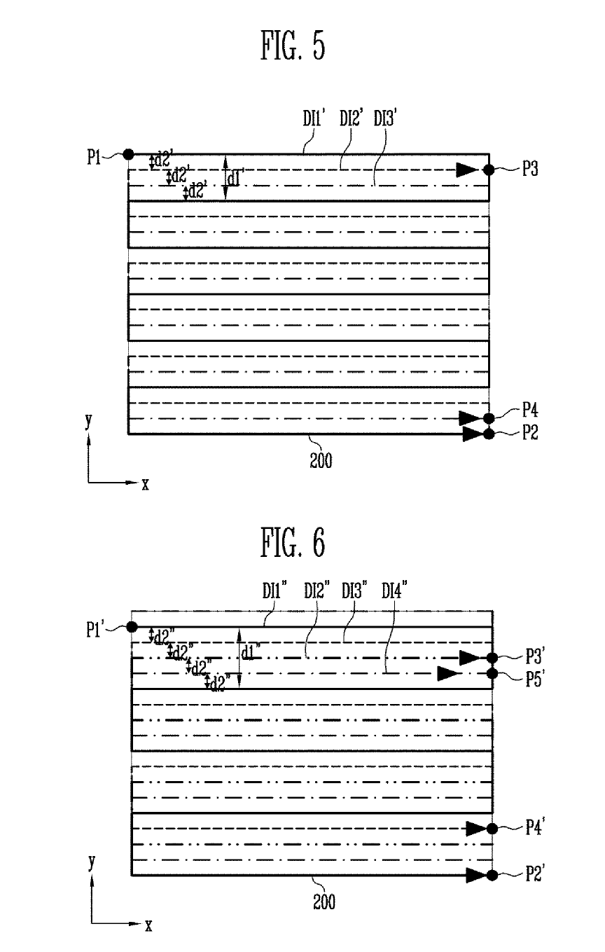

FIG. 6 is a conceptual view illustrating a method of operating a scanning device according to another embodiment of the invention.

Since a jump over 3 line interlaced method shown in FIG. 6 includes similar technical features to the jump to line by line interlaced method shown in FIGS. 4A, 4B, and 4C, a detailed description thereof will be omitted.

Referring to FIG. 6, the transmitting module 120 may continuously emit the laser beam LS along a first scan path DI1″, a second scan path DI2″, a third scan path DI3″, and a fourth scan path DI4″.

The transmitting module 120 may emit the laser beam LS from a first scan point P1′ to a second scan point P2′ along the first scan path DI1″, emit the laser beam LS from the second scan point P2′ to a third scan point P3′ along the second scan path DI2″, emit the laser beam LS from the third scan point P3′ to a fourth scan point P4′ along the third scan path DI3″, and emit the laser beam LS from the fourth scan point P4′ to a fifth scan point P5′ along the fourth scan path DI4″.

The first scan path DI1″, the second scan path DI2″, the third scan path DI3″, and the fourth scan path DI4″ may be arranged at predetermined distances on the subject 200.

For example, first and second paths of each of the first scan path DI1″, the second scan path DI2″, the third scan path DI3″, and the fourth scan path DI4″ may be spaced apart from each other by a first distance d1″. In addition, each of the first scan path DI1″, the second scan path DI2″, and the third scan path DI3″ may be separated from a neighboring scan path by a second distance d2′.

The signal processing module 110 may generate a first subframe by using the reflected laser beam RLS along the first scan path DI1″, generate a second subframe by using the reflected laser beam RLS along the second scan path DI2″, generate a third subframe by using the reflected laser beam RLS along the third scan path DI3″, and generate a fourth subframe by using the reflected laser beam along the fourth scan path DI4″.

The signal processing module 110 may generate a single 3D image with respect to the shape of the subject 200 by overlapping the first subframe, the second subframe, the third subframe, and the fourth subframe.

In other words, since each of the first subframe, the second subframe, the third subframe, and the fourth subframe is an image reflecting a portion of the subject 200, the signal processing module 110 may scan the entire shape of the subject 200 by overlapping the first subframe, the second subframe, the third subframe, and the fourth subframe.

For convenience of explanation, the irradiation of the laser beam LS in order of the first scan path DI1″, the second scan path DI2″, the third scan path DI3″, and the fourth scan path DI4″ is illustrated. However, this is only an embodiment. The order in which the laser beam LS is emit onto the first scan path DI1″, the second scan path DI2″, the third scan path DI3″, and the fourth scan path DI4″ may vary.

FIG. 7 is a conceptual view illustrating a method of operating a scanning device according to another embodiment.

Since a strip line interlaced method shown in FIG. 7 includes similar technical features to the jump to line by line interlaced method shown in FIGS. 4A, 4B, and 4C, a detailed description thereof will be omitted.

Referring to FIG. 7, the transmitting module 120 may continuously emit the laser beam LS along a first strip scan path SDI1 and a second strip scan path SDI2.

The transmitting module 120 may emit the laser beam LS from a first scan point P1″ to a second scan point P2″ along the first strip scan path SDI1 and emit the laser beam LS from the second scan point P2″ to a third scan point P3″ along the second strip scan path SDI2.

The signal processing module 110 may generate a first subframe by using the reflected laser beam RLS along the first strip scan path SDI1 and generate a second subframe by using the reflected laser beam RLS along the second strip scan path SDI2.

The signal processing module 110 may generate a single 3D image with respect to the shape of the subject 200 by overlapping the first subframe and the second subframe.

In other words, since each of the first subframe and the second subframe is an image reflecting a portion of the shape of the subject 200, the signal processing module 110 may scan the entire shape of the subject 200 by overlapping the first subframe and the second subframe.

For convenience of explanation, the irradiation of the laser beam LS in order of the first strip scan path SDI1 and the second strip scan path SDI2 is illustrated. However, this is only an embodiment. The order in which the laser beam LS is emitted onto the first strip scan path SDI1 and the second strip scan path SDI2 may vary.

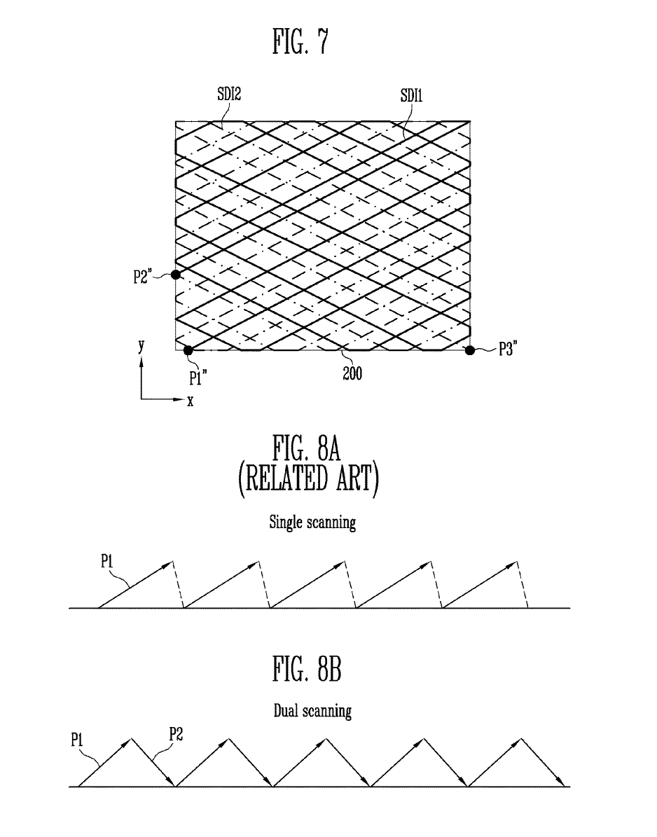

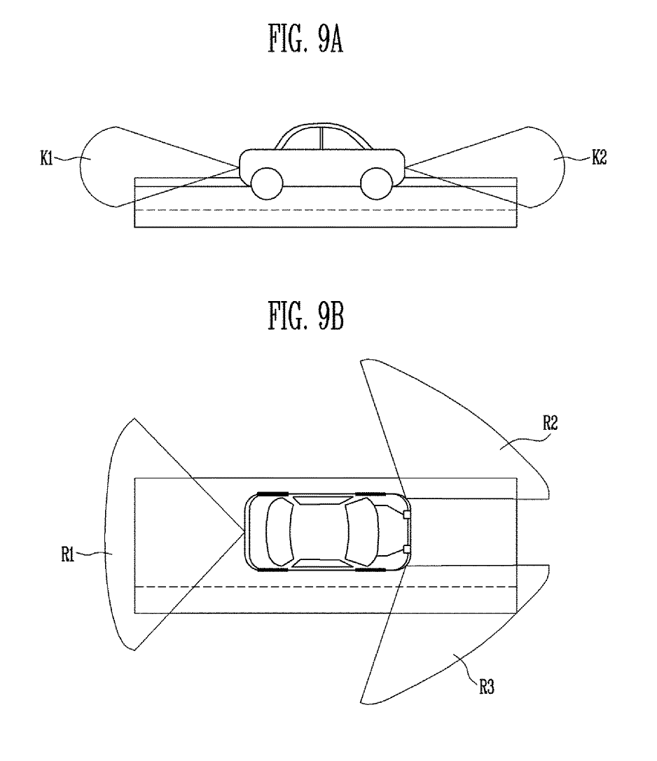

FIG. 8A is a graph illustrating a single scanning operation of a conventional scanning device. FIG. 8B is a graph illustrating a dual scanning operation of a scanning device according to an embodiment.

Referring to FIG. 8A, the conventional scanning device may emit laser beam onto a subject only in a first direction P1.

For example, the conventional scanning device may emit the laser beam from one side to the other side of the subject, pause the irradiation of the laser beam, and resume emitting the laser beam from one side of the subject.

Since the conventional scanning device emits the laser beam only in a direction from one side to the other side of the subject, repetitive scanning interruptions may occur and excessive scanning consumption and disconnection may occur. Therefore, the scanning method by the conventional scanning device may have poor scanning efficiency due to the repetitive scanning interruptions.

Referring to FIGS. 1, 2, and 8B, the scanning device 100 may emit the laser beam LS on the subject 200 in the first direction P1 and the second direction P2 by using a dual scanning method. The first direction P1 may refer to a direction opposite to the second direction P2.

For example, the transmitting module 120 may emit the laser beam LS onto the subject 200 in a direction from one side to the other side, and emit the laser beam LS in the opposite direction without overlapping.

According to an embodiment, since the scanning device continuously emits the laser beam LS in the first direction P1 and the second direction P2 without scanning interruptions, scanning consumption and disconnection may be prevented, and 3D image data having a speed twice as fast as the conventional scanning method may be acquired.

FIGS. 9A and 9B are conceptual views illustrating a car including a scanning device according to an embodiment.

Referring to FIGS. 1, 2, and 9A, a scanning device according to an embodiment may be mounted onto a car and perform a scanning operation.

The car may scan subjects arranged in a forward direction K1 and a backward direction K2 by using the scanning device 100 and perform a scanning operation by using the scanning device 100 during high-speed driving.

Referring to FIGS. 1, 2, and 9B, the car may scan the subjects 200 arranged in a first direction R1, a second direction R2, and a third direction R3 at the same time by using the scanning device 100.

According to an embodiment, r the scanning device 100 may scan the subjects within different ranges in the first direction R1, the second direction R2, and the third direction R3.

The method of operating the scanning device included in the car described with reference to FIGS. 9A and 9B is illustrated for convenience of explanation. However, the present invention is not limited thereto. The scanning device according to the embodiment may be included in various types of transportation facilities, such as airplanes, motorcycles, and bicycles, and perform the scanning operation.

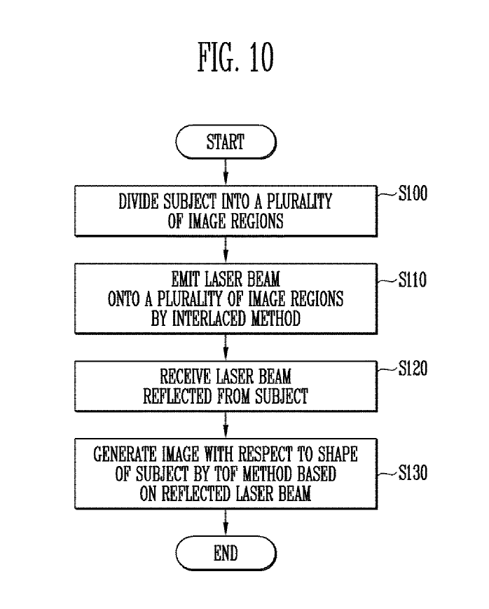

FIG. 10 is a flowchart illustrating a method of operating a scanning device according to an embodiment.

Referring to FIGS. 1, 2, and 10, the scanning device 100 may divide the subject 200 into a plurality of image regions (S100).

The scanning device 100 may emit the laser beam LS onto the plurality of image regions by an interlaced method (S110). The scanning device 100 may bidirectionally or multidirectionally emit the laser beam LS onto the plurality of image regions by an interlaced method.

The scanning device 100 may receive the reflected laser beam RLS from the subject 200 (S120).

The scanning device 100 may generate an image with respect to the shape of the subject 200 by a Time Of Flight (TOF) method based on the reflected laser beam RLS (S130). The scanning device 100 may generate a single 3D image with respect to the shape of the subject 200 by overlapping a plurality of subframes corresponding to the reflected laser beam RLS.

According to a scanning device and an operating method thereof according to an embodiment, a high-speed 3D image may be acquired without distortion through programming of a scanning pattern by an interlaced method without adding a separate hardware component, and a plurality of subframes may be generated as a single 3D image by an overlapping technique.

In addition, according to a scanning device and an operating method thereof according to an embodiment, a bidirectional round trip of the scanning device may be performed by using dual pattern scanning, but not single pattern scanning, and a target may be scanned at a speed twice as fast as single pattern scanning by the bidirectional round trip.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A scanning device, comprising:
a transmitting module dividing a subject into a plurality of image regions and emitting laser beam onto the plurality of image regions by an interlaced method;
a receiving module receiving reflected laser beam from the subject; and
a signal processing module scanning a shape of the subject by a Time Of Flight (TOF) technique based on the reflected laser beam,
wherein the signal processing module generates a single image with respect to the shape of the subject by overlapping subframes generated by the interlaced method.

2. The scanning device of claim 1, wherein the transmitting module emits the laser beam onto the plurality of image regions along a first path and emits the laser beam along a second path starting from a scan end point of the first path, wherein the second path is in an opposite direction to the first path.

3. The scanning device of claim 2, wherein the first path and the second path do not overlap with each other.

4. The scanning device of claim 2, wherein the first path and the second path alternate with each other at a predetermined distance on the plurality of image regions.

5. The scanning device of claim 2, wherein the signal processing module generates a first subframe by using the laser beam reflected along the first path and a second subframe by using the laser beam reflected along the second path.

6. The scanning device of claim 5, wherein the signal processing module generates the single image by overlapping the first subframe and the second subframe.

7. The scanning device of claim 1, wherein the single image is a three-dimensional (3D) image.

8. A method of operating a scanning device, the method comprising:
dividing a subject into a plurality of image regions;
emitting laser beam onto the plurality of image regions by an interlaced method;
receiving reflected laser beam from the subject; and
generating an image with respect to a shape of the subject by a Time Of Flight (TOF) technique based on the reflected laser beam.

9. The method of claim 8, wherein the image is a 3D image.

10. The method of claim 8, wherein the emitting of the laser beam comprises:
emitting the laser beam onto a first image region, among the plurality of image regions, along a first path; and
emitting the laser beam onto remaining image regions along a second path separated from the first path by a predetermined distance.

11. The method of claim 10, wherein a scan end point of the first path coincides with a scan start point of the second path.

12. The method of claim 10, wherein a direction of the first path is opposite to a direction of the second path.

13. The method of claim 10, wherein the direction of the first path is in parallel with the direction of the second path.

14. The method of claim 10, wherein the generating of the image comprises:
generating a first subframe on the basis of the reflected laser beam along the first path;
generating a second subframe on the basis of the reflected laser beam along the second path; and
generating a single image by overlapping the first subframe and the second subframe.

15. The method of claim 8, wherein the emitting of the laser beam comprises emitting the laser beam onto the plurality of image regions along a bidirectional round trip path.
